(19) United States
(12) Patent Application Publication
(10) Pub. No.: US 2024/0262662 A1
(43) Pub. Date: Aug. 8, 2024

(54) FORKLIFT/MATERIAL HANDLING FORK LEVEL INDICATOR

(71) Applicants: Gregory Michael Grierson, Dayton, OH (US); Gregory Michael Grierson, JR., Dayton, OH (US)

(72) Inventors: Gregory Michael Grierson, Dayton, OH (US); Gregory Michael Grierson, JR., Dayton, OH (US)

(21) Appl. No.: 18/105,818

(22) Filed: Feb. 4, 2023

(51) Int. Cl. B66F 9/075

(52) U.S. Cl. CPC B66F 9/0755

(57) ABSTRACT

Material handling procedures involve safety, productivity, and efficiency constraints. Among these is inability of equipment operators accurately determining the alignment of equipment forks to the transport structure being handled. The “Forklift/Material Handling Fork Level Indicator” eliminates this. Employing an angled baseplate and reflective surface, indicator, and position reference, the equipment operator can “see around a corner.” The operator can determine equipment mast vertical condition, fork-to-floor parallelism, and accurate alignment of equipment forks to any transport structure upon approach to or withdraw from said transport structures. Attached to the main vertical mast of material handling equipment, this device provides a side-view of the main mast position via the freely rotating indicator relative to the position reference. This view is directly visible to the equipment operator via the reflective surface.

### BRIEF SUMMARY

This invention provides a visual indication that the forks or loading surfaces of material handling equipment are in the state of being parallel to the floor. Loading slots on transport structures are more easily retrievable for the equipment operator by observing the indicator relative to the position reference in real time by way of the reflective surface. This eliminates the need for the operator to lean out from under a protective cage or require an ancillary observer to determine level compromising their own safety. These characteristics greatly enhance pick and place procedures efficiently while stationary or in motion. By providing level entry into any transport structure, the forklift operator greatly reduces misalignment which can result in push-offs, spills, damage, injury, or death.

The device is purely mechanical relying only on light and gravity. This simple design eliminates the need for batteries, wires, or any other electrical component, ultimately removing points of failure. The unique feature of this invention is that it provides the operator with a side view of the main mast from the equipment operator's safest operating position.

### Invention

The invention is an assembly of an angled baseplate with one hole, reflective surface, and indicator which rotates from a fastener relative to the position reference. The position reference surface is parallel to the main mast upon which the baseplate is attached. The reflective surface faces the operator providing the necessary view to perform any leveling procedure (See FIG. 6B). Line of sight is maintained to the reflective surface and position reference regardless of load height because the main mast pivots at a fulcrum affixed to the material handling equipment frame (See FIG. 6A). Because material handling equipment varies in size, this invention can be scaled to accommodate any size material handling equipment to maintain the operators leveling capabilities using this technology. To our knowledge this a novel invention which claims prior benefit of a previously granted patent.

### Manufacture

The baseplate is manufactured from weatherproof, corrosion-resistant, and or recyclable materials. The angle of the baseplate is established for operator use so that the position reference can be seen at the safest operating position with one hole in the position reference surface (See FIG. 4). The position reference consists of a graduated scale with a center mark and reverse typographic, alphanumeric text, symbols and or glyphs to indicate forward or backward positioning in normal typographic composition to the operator via the reflective surface. The reflective surface is composed of any reflective material including tapes, mirrors, and or polished surfaces with optimal reflectance and positioned on the angled baseplate surface that is appropriate for operating conditions. The indicator is composed of weatherproof, corrosion-resistant, and or recyclable material. The indicator is attached using a fastener which allows the indicator to rotate freely along the position reference. Axial deviation is controlled by bushings in concert with the fastener. The invention is completed with an appropriate attachment media or method from baseplate to main mast that is suitable for a variety of material handling equipment masts or frames.

### Installation and Use

Installation begins with thorough cleaning of installation surface on the outboard side of the material handling equipment's main mast. The device is attached to the material handling equipment flush to the operator-side edge of the frame and or main vertical mast which aligns the devices pivot point and the position reference. Once installed, the attachment media or method should be given adequate cure time if tapes or adhesives are used. Bolts or magnet attachments are alternative installation methods dependent upon the type of material handling equipment, size, capacity, variety and its own specifications.

While retrieving a transport structure from a storage structure, the material handling operator adjusts the forks to align the indicator to the position reference by way of the reflective surface. Thus, the vertical mast is plumb, and the forks are parallel to the floor for interference-free entry for pick or place of any transport structure. Interference-free entry negates aforementioned safety issues including push-offs, spills, damage, injury and death.

### Safety Considerations

The safest place for a material handling equipment operator to be is under the protective cage and wearing a seatbelt (Paulausky, 2013; McCue Corporation, 2018). OSHA states that 70% of forklift-related accidents could be prevented (McCue Corporation, 2018). This invention may significantly REDUCE annual forklifts accidents and we foresee this invention becoming a REQUIRED safety device on material handling equipment in the future.

### DESCRIPTION OF SEVERAL DRAWINGS

FIG. 1. Exploded isometric view of the invention showing the orientation and assembly order of the component parts of the device. The fastener, 1. is fitted with bushing 2., and bushing 3. This holds the indicator 4. in close proximity to the baseplate 5. The fastener is secured by a washer 6. A position reference 9. is affixed to the baseplate below the indicator reflecting the indicator position to the operator by way of the reflective surface 8. An attachment media 7. allows the device to be mounted to the mast of the material handling equipment providing a side-view of the mast vertical condition to the operator while seated in the safest operating position.

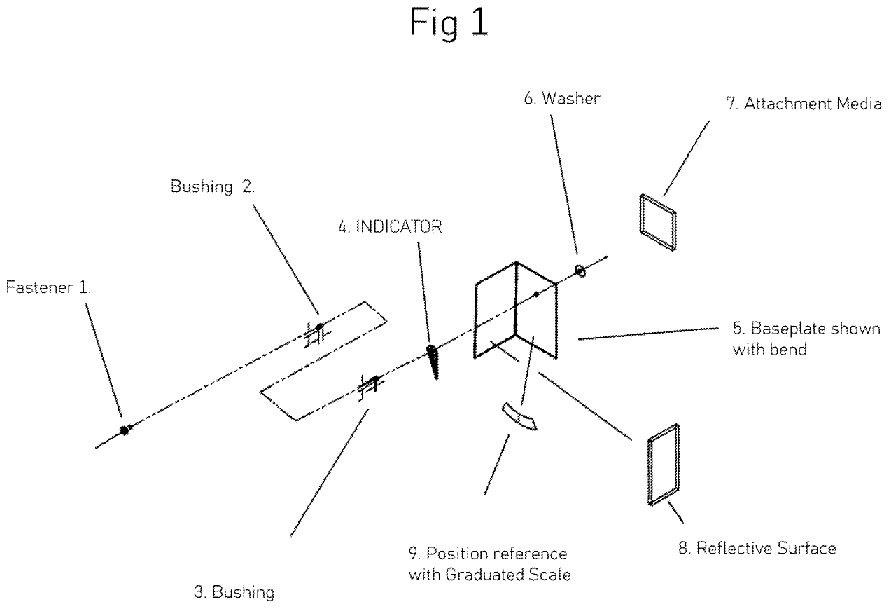

FIG. 2. Orthographic view showing the angled baseplate, top-view, side-view, and front-view, which facilitates reflection of the indicator to the operator by way of the reflective surface.

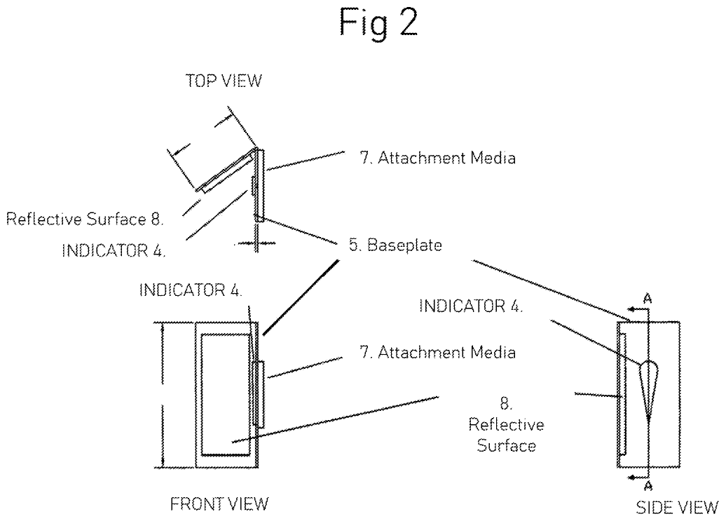

FIG. 3. Detail view of Section AA (FIG. 2) showing angled baseplate, indicator, fastener, bushings, and washer. This view shows the gap between the indicator and the baseplate on indicator side.

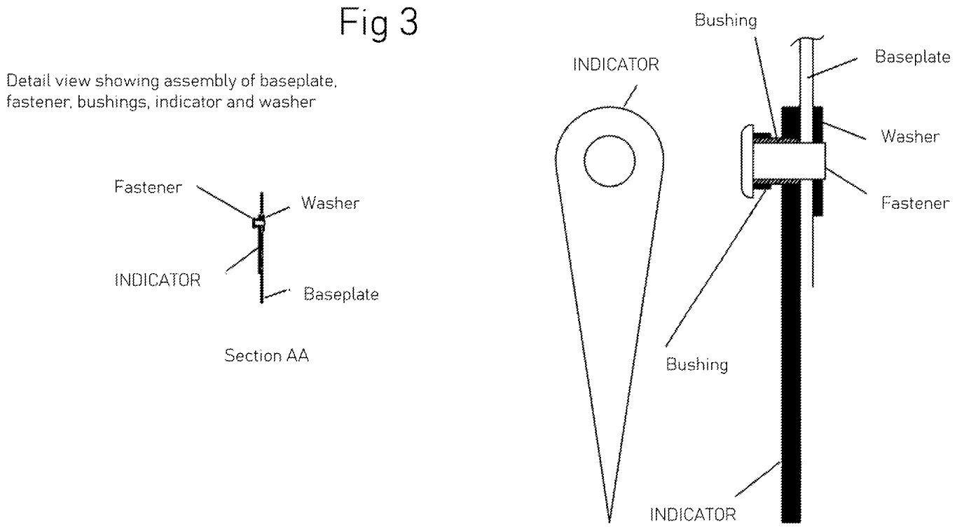

FIG. 4. Typical installation position of the device on the main mast of the material handling equipment. The left-most illustration on FIG. 4 shows the device mounted on the vertical mast within the line of sight of the material handling equipment operator. The right-most illustrations on FIG. 4 shows indicator-to-position reference positions. As the forks are tilted backward and forward, the indicator rolls to the positions indicated.

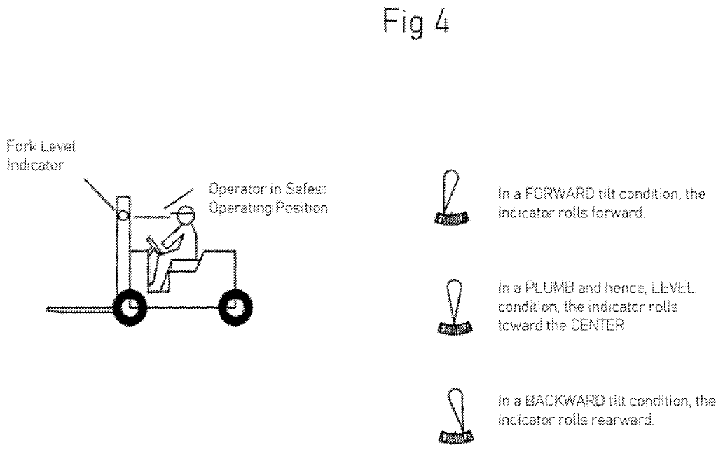

FIG. 5. A detailed view of the graduated position reference which is placed directly below the indicator on the indicator-side of the angled baseplate. The tilt positions (Forward and Backward) are denoted by alphanumeric text, symbols, phrases, and or glyphs in reverse composition. Depending on regional and global device use, an example of universal symbols, or regionally specific symbols, phrases, alphanumeric text, and or glyphs are shown in the bottom right of FIG. 5. Any alphanumeric text, symbol, phrase, and or glyph will be reflected back to the operator by way of the reflective surface in normal composition.

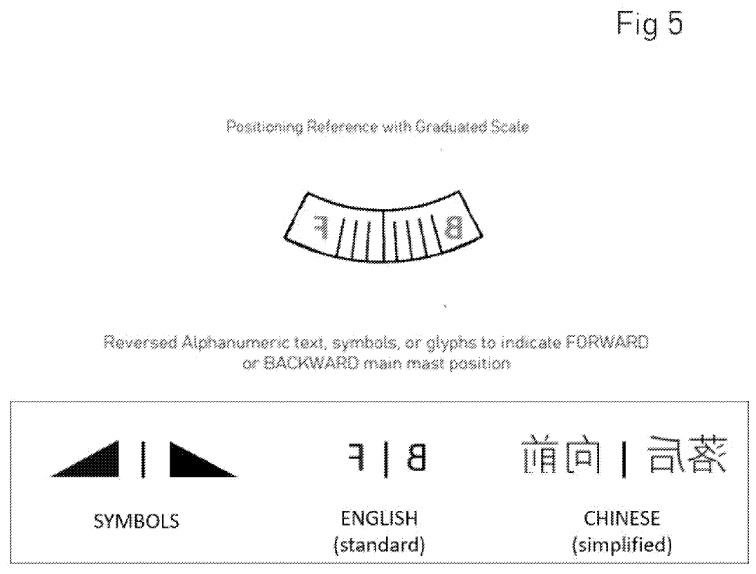

FIG. 6. Shows side view of load height relative to the operator in the safe operating position with the device in operator line of sight (6A). Regardless of load height, the vertical mast condition is reflected to the operator by way of the reflective surface in conjunction with the indicator and the position reference (6B).

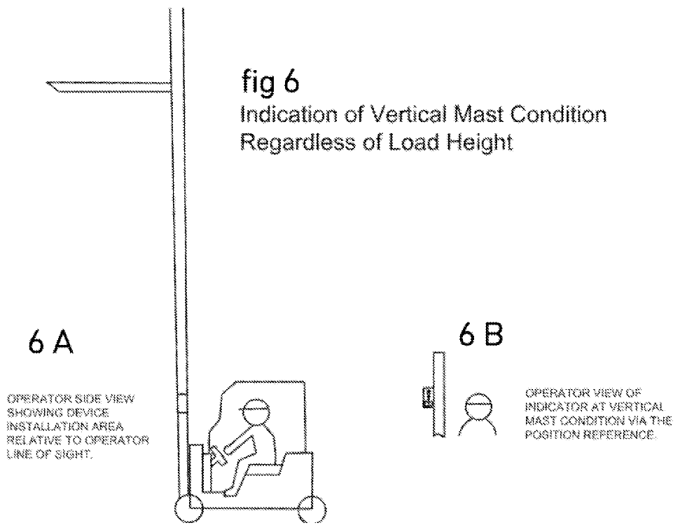

### LIST OF COMPONENT PARTS

1. Fastener
2. Bushing
3. Bushing
4. Indicator
5. Baseplate shown with bend
6. Washer
7. Attachment Media
8. Reflective Surface
9. Position Reference with Graduated Scale

1. A device providing visual indication of mast side view and therefore mast plumb or tilt condition directly to the operator of forklift material handling equipment, said device comprising:
an angled baseplate, standing on end, resembling a partially opened book, and forming two inner surfaces,
a reflective surface on the operator-facing surface of the baseplate,
a fastener about which pivots
an indicator along
a position reference
said indicator fitted with bushings to provide a gap between said indicator and said baseplate.

2. A device as recited in claim 1 further comprising:
a graduated position reference imprinted with center mark, and forward and backward tilt reverse typographic, alphanumeric text, symbols and or glyphs. Thus, providing a reflected indication of vertical mast and fork-to-floor parallelism.

3. A device as recited in claim 1 further comprising:
an attachment media for securing said device to the material handling equipment mast.
